(19) United States
(12) Patent Application Publication
(10) Pub. No.: US 2017/0275507 A1
(43) Pub. Date: Sep. 28, 2017

(54) POLYCHLOROPRENE-BASED BONDING ADHESIVES

(71) Applicants: FIRESTONE BUILDING PRODUCTS CO., LLC, Indianapolis, IN (US); ROYAL ADHESIVES AND SEALANTS, LLC, South Bend, IN (US)

(72) Inventors: Daryl D. MEYER, Goshen, IN (US); Yoel Siyahu ATTIYA, Mishawaka, IN (US); Joseph John KALWARA, Indianapolis, IN (US); William B. GORMAN, Mooresville, IN (US); Todd David TAYKOWSKI, Noblesville, IN (US)

(21) Appl. No.: 15/618,746

(22) Filed: Jun. 9, 2017

Related U.S. Application Data
(63) Continuation of application No. 14/499,778, filed on Sep. 29, 2014, now abandoned.
Application No. 14/499,778 is a continuation of application No. 13/946,291, filed on Jul. 19, 2013, now abandoned.
Application No. 13/946,291 is a continuation of application No. 12/761,032, filed on Apr. 15, 2010, now abandoned.
(60) Provisional application No. 61/308,955, filed on Feb. 28, 2010.
(60) Provisional application No. 61/169,598, filed on Apr. 15, 2009.

(51) Int. Cl. C09J 111/00; B32B 37/12; B32B 37/18; B32B 38/16; C08K 3/22; C08K 5/01; C08K 5/07; C08K 5/101; C09J 109/06; C09J 123/12; E04D 5/14; C08L 9/06

(52) U.S. Cl. CPC C09J 111/00; B32B 37/1284; B32B 38/16; C09J 109/06; C09J 123/12; C08K 3/22; C08K 5/01; C08K 5/101; E04D 5/148; B32B 37/18; C08K 5/07; B32B 2419/06; C08K 2003/2296; C08L 9/06; B32B 2398/10; B32B 2323/00; B32B 2386/00

(57) ABSTRACT

An adhesive composition comprising a solids component, said solids component including a rubber component that includes polychloroprene; and a solvent component, said solvent component including t-butyl acetate.

This application is a continuation application of U.S. Non-Provisional application Ser. No. 14/499,778 filed Sep. 29, 2014, which is a continuation application of U.S. Non-Provisional application Ser. No. 13/946,291, filed on Jul. 19, 2013, which is a continuation application of U.S. Non-Provisional application Ser. No. 12/761,032, filed on Apr. 15, 2010, and claims the benefit of U.S. Provisional Application Ser. No. 61/169,598, filed Apr. 15, 2009, and U.S. Provisional Application Ser. No. 61/308,955, filed on Feb. 28, 2010, which are incorporated herein by reference.

### FIELD OF THE INVENTION

One or more embodiments of the present invention are directed toward polychloroprene-based bonding adhesives that include a t-butyl acetate-based solvent system.

### BACKGROUND OF THE INVENTION

Polymeric membranes, such as cured sheets of ethylene-propylene-diene copolymer rubber (EPDM) or extruded sheet of thermoplastic olefins (TPO), are often used in the construction industry to cover flat or low-sloped roofs. These membranes, which may also be referred to as panels, are typically delivered to a construction site in a bundled roll, transferred to the roof, and then unrolled and positioned. The sheets are then affixed to the building structure by employing varying techniques such as mechanical fastening, ballasting, and/or adhesively adhering the membrane to the roof. The roof substrate to which the membrane is secured may include a variety of materials depending on the situation. For example, the surface may be a concrete, metal, or wood deck, it may include insulation or recover board, and/or it may include an existing membrane.

In addition to securing the membrane to the roof—which mode of attachment primary seeks to prevent wind uplift—the individual membrane panels, together with flashing and other accessories, are positioned and adjoined to achieve a waterproof barrier on the roof. Typically, the edges of adjoining panels are overlapped, and these overlapping portions are adjoined to one another through a number of methods depending upon the membrane materials and exterior conditions. One approach involves providing adhesives or adhesive tapes between the overlapping portions, thereby creating a water-resistant seal.

Thus, there are two modes of membrane attachment that are used in conjunction. The first seeks to anchor the membrane to the roof, while the second seeks to create a water-impervious barrier by attaching individual adjacent membrane panels to each other or to flashing. Inasmuch as these modes of membrane attachment seek entirely different goals, the mechanisms by which they operate are likewise distinct.

With respect to the former mode of attachment, which involves securing of the membrane to the roof, the use of adhesives may allow for the formation of a fully-adhered roofing system. In other words, a majority, if not all, of the membrane panel is secured to the roof substrate as opposed to mechanical attachment methods which can only achieve direct attachment in those locations where a mechanical fastener actually affixes the membrane.

When adhesively securing a membrane to roof, such as in the formation of a fully-adhered system, one common method employed includes contact bonding whereby technicians coat both the membrane and the substrate to receive membrane with an adhesive, and then mate the membrane with the substrate via the partially-set adhesive. Because the volatile components (e.g. solvent) of the adhesives are “flashed off” prior to mating, good, early (green) bond strength is developed.

While both solvent-based and water-based adhesives may be used as contact adhesives, solvent-based bonding adhesives offer advantages. For example, the flash-off period, which is the time required to allow solvent evaporation prior to mating, can be between 5 and 40 minutes, and is less susceptible to environmental conditions, such as temperature, than water-based adhesive systems. Solvent-based systems, on the other hand, can be problematic. For example, the solvent employed in the system can cause membrane swelling and/or blistering. It is believed swelling and blistering results from solvent compatibility with the membrane and/or a component of the membrane. Other problems can include blushing, which is the formation of condensation on the surface of the film formed upon application of the adhesive to the membrane. Blushing can have a deleterious impact on the bond strength and/or quality of the bond formed by the adhesive and is therefore not desirable.

For at least these reasons, improved bond adhesives are desired.

### SUMMARY OF THE INVENTION

One or more embodiments of the present invention provide an adhesive composition comprising a solids component, said solids component including a rubber component that includes polychloroprene; and a solvent component, said solvent component including t-butyl acetate

One or more embodiments of the present invention still further provide an adhesive composition comprising a solids component, said solids component including a rubber component, a synthetic thermosetting resin, and a hydrocarbon resin, where the rubber component includes polychloroprene; and a solvent component, said solvent component including t-butyl acetate, toluene, acetone, and methyl acetate.

One or more embodiments of the present invention still further provide a method of contact bonding a roofing membrane to a substrate, the method comprising applying a contact adhesive composition to a portion of a roofing membrane panel to form a wet film on the membrane panel; applying a contact adhesive composition to at least a portion of a substrate to form a wet film on the substrate; allowing the wet film on the membrane and the wet film on the substrate to set up for desirable contact bonding; and mating the membrane to the substrate, where the adhesive composition includes a solids component, said solids component including a rubber component, a synthetic thermosetting resin, and a hydrocarbon resin, where the rubber component includes polychloroprene; and a solvent component, said solvent component including t-butyl acetate, toluene, acetone, and methyl acetate

### DETAILED DESCRIPTION OF ILLUSTRATIVE EMBODIMENTS

Embodiments of the present invention are directed toward polychloroprene-based adhesive compositions that include a t-butyl acetate-based solvent system. The polychloroprene-based adhesive compositions can be used to form wet films on polymeric substrates (e.g., rubber membrane) that can ultimately be used to bond the polymeric substrates to other substrates (e.g., isocyanate construction boards. In other words, the compositions of this invention can be used as a contact adhesive, which may also be referred to as a bond adhesive. The wet films can ultimately form a cured adhesive between the substrates.

The use of a t-butyl acetate-based solvent system has lead to several unexpected advantages. For instance, the t-butyl acetate-based solvent system serves as an advantageous solvent for the solids portion of the adhesive composition and provides an advantageous shelf life for the composition. Also, the solvent system provides a wet film that exhibits advantageous open time and that shows advantageous resistance to blushing. Still further, the wet films formed from the adhesive compositions of this invention exhibit technological advantages in that less deleterious impact on polymeric substrates is observed including less swelling and blistering than conventional systems commercially used.

In one or more embodiments, the solids component of the adhesive compositions of this invention is polychloroprene-based. In one or more embodiments, the polychloroprene component is the largest single solids component, on a weight basis, within the composition. The solids component may optionally also include complementary solids components. These components may include one or more other elastomers, thermosetting synthetic resins, hydrocarbon resins, adhesion promoters, fillers, antioxidants, and other optional ingredients conventionally employed in the art.

In particular embodiments, polychloroprene includes polymers that derive from the polymerization of halogenated dienes and optionally monomer copolymerizable therewith. An example is 2-chloro-1,3-butadiene, which is also known as chloroprene. Monomer copolymerizable with chloroprene includes 2,3-dichloro-1,3-butadiene. While homopolymers of chloroprene may be referred to as polychloroprene, for purposes of this description, the rubbers deriving from the copolymerization of chloroprene and monomer copolymerizable therewith may also be referred to as polychloroprene or may be distinctly referred to as polychloroprene copolymers.

In one or more embodiments, polychloroprene or polychloroprene copolymers employed in the practice of this invention may be characterized by a Mooney viscosity (ML₁₊₄ at 100° C.) of at least 25, in other embodiments at least 40, in other embodiments at least 60, in other embodiments at least 80, and in other embodiments at least 100. In these or other embodiments, the polychloroprene or polychloroprene copolymers may be characterized by a Mooney viscosity (ML₁₊₄ at 100° C.) of less than 150, in other embodiments less than 130, in other embodiments less than 110 in other embodiments less than 80, in other embodiments less than 60, and in other embodiments less than 50. In particular embodiments, the polychloroprene or polychloroprene copolymers may be characterized by a Mooney viscosity (ML₁₊₄ at 100° C.) of from about 100 to about 120, and in other embodiments from about 41 to about 51.

In one or more embodiments, blends of distinct polychloroprene or polychloroprene copolymers may be employed to achieve a desirable balance of properties. These distinctions may be based upon comonomer content and/or viscosity of the polymers.

Useful examples of desirable polychloroprene or polychloroprene copolymers are available from Bayer Material Science (Germany) under the trade name Baypren™ 213-1, which is a poly-2-chlorobutadiene-1,3, having a solution viscosity (10% in toluene at 23° C.) using Brookfield DVII viscometer LV-spindle no. 2 at 60 min₋₁) of 145±75 mPa•s and Baypren 233-1, which is a poly-2-chlorobutadiene-1,3, having a solution viscosity (10% in toluene at 23° C.) using Brookfield DVII viscometer LV-spindle no. 2 at 60 min₋₁) 850±150 mPa•s. Others are available from DuPont Performance Elastomers (Wilmington, Del.) under the Neoprene™ “WD” and “WRT” family designations. It is believed that Neoprene™ WD and WRT are relatively crystallization-resistant, versus Neoprene™ G-type, and are copolymers of chloroprene and 2,3-dichloro-1,3-butadiene. Neoprene™ WD exhibits a Mooney Viscosity range (ML₁₊₄ at 100° C.) of 100-120, while Neoprene™ WRT exhibits a Mooney Viscosity range (ML₁₊₄ at 100° C.) of 41-51.

In one or more embodiments, the complementary rubber may include vulcanizable rubber, which may also be referred to as elastomer, and therefore include those polymers that are capable of being cured (also referred to as vulcanized) to form elastomeric compositions of matter.

Exemplary elastomers include natural rubber, synthetic polyisoprene, polybutadiene, polyisobutylene-co-isoprene, polychloroprene, poly(ethylene-co-propylene), poly(styrene-co-butadiene), poly(styrene-co-isoprene), and poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, and mixtures thereof.

In one or more embodiments, synthetic thermosetting resins include those materials obtained by the condensation of phenol or substituted phenol with an aldehyde. These materials may also be referred to as phenolic resins. An example of a useful thermosetting synthetic resin is butylphenol-formaldehyde. As is known in the art, these resins may be used in conjunction with water as a reactant.

In one or more embodiments, hydrocarbon resins include synthetic resins, synthetic oligomers, natural resins, or combinations thereof.

The monomer that may be polymerized to synthesize the synthetic resins or low molecular weight polymers or oligomers may include those obtained from refinery streams containing mixtures or various unsaturated materials or from pure monomer feeds. The monomer may include aliphatic monomer, cycloaliphatic monomer, aromatic monomer, or mixtures thereof. Aliphatic monomer can include C₄, C₅, and C₆ paraffins, olefins, and conjugated diolefins. Examples of aliphatic monomer or cycloaliphatic monomer include butadiene, isobutylene, 1,3-pentadiene (piperylene) along with 1,4-pentadiene, cyclopentane, 1-pentene, 2-pentene, 2-methyl-1-pentene, 2-methyl-2-butene, 2-methyl-2-pentene, isoprene, cyclohexane, 1-3-hexadiene, 1-4-hexadiene, cyclopentadiene, and dicyclopentadiene. Aromatic monomer can include C₈, C₉, and C₁₀ aromatic monomer. Examples of aromatic monomer includes styrene, indene, derivatives of styrene, derivatives of indene, and combinations thereof.

Examples of these resins include aliphatic hydrocarbon resins, at least partially hydrogenated aliphatic hydrocarbon resins, aromatic hydrocarbon resins, at least partially hydrogenated aromatic resins, aliphatic/aromatic hydrocarbon resins, at least partially hydrogenated aliphatic/aromatic hydrocarbon resins, cycloaliphatic hydrocarbon resins, at least partially hydrogenated cycloaliphatic resins, cycloaliphatic/aromatic hydrocarbon resins, at least partially hydrogenated cycloaliphatic/aromatic hydrocarbon resins, at least partially hydrogenated aromatic hydrocarbon resins, polyterpene resins, terpene-phenol resins, rosin esters, and mixtures of two or more thereof.

In one or more embodiments, adhesion promoters include polyolefins. In particular embodiments, these polyolefins include functionalized polyolefins. As is known in the art, the polyolefins may derive from ethylene or a-olefins such as, but not limited to, propylene, butene, pentene, and octene. In particular embodiments, the polyolefin includes isotactic polypropylene. In other embodiments, copolymers of propylene and comonomers such as ethylene and/or octene are contemplated.

In one or more embodiments, the polyolefins may be functionalized by halogenation (i.e., they are modified to include pendant halogen atoms) or by other polar-group modification (i.e., include pendant polar groups). For example, and as is known in the art, the backbone of a polyolefin can be functionalized with an anhydride (e.g., maleic acid).

In particular embodiments, the polyolefins are functionalized by chlorination. Methods for functionalizing polyolefins (e.g., anhydride modification or halogenation) are known in the art. The degree of functionalization may vary based on the type of functionality. For example, where the polyolefin is functionalized with an anhydride, the degree of functionalization is typically below 10 weight percent. On the other hand, where the polyolefin is halogenated (e.g., chlorinated), higher degrees of functionalization may be useful (e.g., chlorination of 15-30 weight percent). An example of a useful adhesion promoter is that commercially available under the tradename HARDLEN 13LP (Advanced Polymer, Inc., Carlstadt, N.J.).

In one or more embodiments, the molecular weight of the polyolefins (number average molecular weight) may be at least 100 kg/mole, in other embodiments at least 120 kg/mole, and in other embodiments at least 140 kg/mole. In these or other embodiments, the molecular weight of the polyolefins may be less than 250 kg/mole, in other embodiments less than 200 kg/mole, and in other embodiments less than 180 kg/mole.

In particular embodiments, the adhesion promoters (e.g., chlorinated polypropylene) may be used in lieu of other constituents within the solids component of the bond adhesives of this invention. For example, the adhesion promoters may be used in lieu of a complementary elastomer (e.g., poly(styrene-co-butadiene)).

Other constituents that may be used in the composition include reinforcing and non-reinforcing fillers, antioxidants, stabilizers, pigments, flame retardants and other compounds used in the adhesive art. Fillers that can be utilized include conventional inorganics such as calcium carbonate, clays, silica, talc, titanium dioxide, magnesium oxide, zinc oxide, carbon black, and the like.

In one or more embodiments, the solvent component of the adhesive compositions of the present invention is t-butyl acetate-based. In particular embodiments, t-butyl acetate is the largest single solvent component, on a weight basis, within the composition. The term solvent is used in a conventional manner. For example, solvent refers to a substance capable of dissolving another substance (solute) to form a uniformly dispersed mixture or solution at the molecular or ionic size level. In this case, the solvent is capable of dissolving one or more of the solids components of the adhesive composition, which may also be referred to as solute. In one or more embodiments, the solvent component may also include complementary solvents, which may include organic solvents other than t-butyl acetate.

Exemplary organic solvents other than t-butyl acetate include hydrocarbons with a low or relatively low boiling point, such as aromatic hydrocarbons, aliphatic hydrocarbons, and cycloaliphatic hydrocarbons. Non-limiting examples of aromatic hydrocarbons include benzene, toluene, xylenes, ethylbenzene, diethylbenzene, and mesitylene. Non-limiting examples of aliphatic hydrocarbons include n-pentane, n-hexane, n-heptane, n-octane, n-nonane, n-decane, isopentane, isohexanes, isopentanes, isooctanes, 2,2-dimethylbutane, petroleum ether, kerosene, and petroleum spirits. And, non-limiting examples of cycloaliphatic hydrocarbons include cyclopentane, cyclohexane, methylcyclopentane, and methylcyclohexane. Hydrocarbons including heteroatoms may also be used. These include solvents such as ketones, aldehydes, esters, and ethers. Useful ketones include acetone. Useful esters include methylacetate.

Specific embodiments of the present invention may be described with reference to the rubber component of the composition. The rubber component includes the polychloroprene and any other elastomers that may be employed in the composition. In one or more embodiments, at least 70%, in other embodiments at least 75%, and in other embodiments at least 80% of the rubber component includes polychloroprene. In these or other embodiments, less than 99%, in other embodiments less than 95%, and in other embodiments less than 90% by weight of the rubber component includes polychloroprene, with the balance being the complementary elastomer. In particular embodiments, the rubber component includes 100% polychloroprene (e.g., the composition is devoid or substantially devoid of a complementary rubber such as SBR).

In one or more embodiments, the rubber component may include a first polychloroprene rubber characterized by a solution viscosity of from about 70 to about 215 mPa•s, a second polychloroprene characterized by a solution viscosity of from about 700 to about 1,000 mPa•s, and a styrene-butadiene copolymer rubber having a Mooney viscosity of from about 92 to about 99, where the solution viscosity is measured at 10% in toluene at 23° C., using a Brookfield DVII viscometer with an LV-spindle no. 2 at a spindle speed of 60 min₋₁, and the Mooney viscosity is measured at 100° C. using a no. 4 spindle.

In one or more embodiments, the adhesive composition includes at least 50, in other embodiments at least 150, in other embodiments at least 200, in other embodiments at least 250, in other embodiments at least 265, in other embodiments at least 275, and in other embodiments at least 285 parts by weight t-butyl acetate per 100 parts by weight rubber. In these or other embodiments, the adhesive composition includes less than 500, in other embodiments less than 400, in other embodiments less than 375, in other embodiments 340, in other embodiments less than 325, in other embodiments less than 315, and in other embodiments less than 310 parts by weight t-butyl acetate per 100 parts by weight rubber.

In one or more embodiments, the adhesive composition includes 0, in other embodiments at least 5, in other embodiments at least 15, in other embodiments at least 20, in other embodiments at least 25, in other embodiments at least 30, in other embodiments at least 33, and in other embodiments at least 35 parts by weight toluene per 100 parts by weight rubber. In these or other embodiments, the adhesive composition includes less than 300, in other embodiments less than 150, in other embodiments less than 100, in other embodiments 75, in other embodiments less than 60, in other embodiments less than 50, and in other embodiments less than 45 parts by weight toluene per 100 parts by weight rubber.

In one or more embodiments, the adhesive composition includes 0, in other embodiments at least 50, in other embodiments at least 100, in other embodiments at least 125, in other embodiments at least 150, in other embodiments at least 160, in other embodiments at least 165, and in other embodiments at least 170 parts by weight acetone per 100 parts by weight rubber. In these or other embodiments, the adhesive composition includes less than 300, in other embodiments less than 250, in other embodiments less than 235, in other embodiments 225, in other embodiments less than 210, in other embodiments less than 200, and in other embodiments less than 190 parts by weight acetone per 100 parts by weight rubber.

In one or more embodiments, the adhesive composition includes 0, in other embodiments at least 5, in other embodiments at least 10, in other embodiments at least 12, in other embodiments at least 13, in other embodiments at least 14, and in other embodiments at least 15 parts by weight methyl acetate per 100 parts by weight rubber. In these or other embodiments, the adhesive composition includes less than 100, in other embodiments less than 65, in other embodiments 35, in other embodiments less than 30, in other embodiments less than 27, and in other embodiments less than 25 parts by weight methyl acetate per 100 parts by weight rubber.

In one or more embodiments, the adhesive composition includes 0, in other embodiments at least 0.1, in other embodiments at least 0.5, in other embodiments at least 0.7, and in other embodiments at least 0.9 parts by weight water per 100 parts by weight rubber. In these or other embodiments, the adhesive composition includes less than 5, in other embodiments less than 2, in other embodiments 1.5, and in other embodiments less than 1.2 parts by weight water per 100 parts by weight rubber.

In one or more embodiments, the adhesive composition includes at least 20, in other embodiments at least 27, in other embodiments at least 30, and in other embodiments at least 35 parts by weight thermosetting resin per 100 parts by weight rubber. In these or other embodiments, the adhesive composition includes less than 60, in other embodiments less than 50, in other embodiments 45, and in other embodiments less than 39 parts by weight thermosetting resin per 100 parts by weight rubber.

In one or more embodiments, the adhesive composition includes at least 10, in other embodiments at least 15, in other embodiments at least 17, and in other embodiments at least 19 parts by weight hydrocarbon resin per 100 parts by weight rubber. In these or other embodiments, the adhesive composition includes less than 35, in other embodiments less than 30, in other embodiments 27, and in other embodiments less than 24 parts by weight hydrocarbon resin per 100 parts by weight rubber.

In one or more embodiments, the adhesive composition includes at least 1, in other embodiments at least 3, in other embodiments at least 4, and in other embodiments at least 5 parts by weight magnesium oxide per 100 parts by weight rubber. In these or other embodiments, the adhesive composition includes less than 12, in other embodiments less than 10, in other embodiments 9, and in other embodiments less than 7 parts by weight magnesium oxide per 100 parts by weight rubber.

In one or more embodiments, the adhesive composition includes at least 0.5, in other embodiments at least 1.0, in other embodiments at least 1.2, and in other embodiments at least 1.5 parts by weight zinc oxide per 100 parts by weight rubber. In these or other embodiments, the adhesive composition includes less than 5, in other embodiments less than 3.5, in other embodiments 3.0, and in other embodiments less than 2.5 parts by weight zinc oxide per 100 parts by weight rubber.

In one or more embodiments, the adhesive composition includes at least 0.1, in other embodiments at least 0.5, in other embodiments at least 0.7, and in other embodiments at least 0.9 parts by weight antioxidant per 100 parts by weight rubber. In these or other embodiments, the adhesive composition includes less than 5, in other embodiments less than 2, in other embodiments 1.5, and in other embodiments less than 1.2 parts by weight antioxidant per 100 parts by weight rubber.

In one or more embodiments, the adhesive composition includes 0, in other embodiments at least 0.5, in other embodiments at least 1, in other embodiments at least 2, in other embodiments at least 3, and in other embodiments at least 5 parts by weight adhesion promoter (e.g., chlorinated polypropylene) per 100 parts by weight rubber. In these or other embodiments, the adhesive composition includes less than 10, in other embodiments less than 8, in other embodiments less than 5, in other embodiments 4, and in other embodiments less than 2 parts by weight adhesion promoter (e.g., chlorinated polypropylene) per 100 parts by weight rubber.

### Preparation of Adhesive

The adhesive compositions of the present invention may be prepared by batch mixing using conventional batch mixing equipment. In one or more embodiments, the mixer may be equipped with an emulsifier. The mixing can take place under atmospheric pressure and at room temperature. The ingredients can conveniently be introduced to the mixer by first introducing the solvent components followed by the solids ingredients. Mixing may continue until desired viscosity or level of dispersion/solubility is achieved. In particular embodiments, mixing is conducted for at least 100 minutes, in other embodiments at least 150 minutes, in other embodiments at least 180 minutes, and in other embodiments at least 190 minutes. In particular embodiments, mixing is continued until a viscosity of less than 4200 cps, in other embodiments less than 4000 cps, and in other embodiments less than 3800 cps is achieved (#3 spindle @ 71° F.-73° F.). In these or other embodiments, mixing is continued until a viscosity of at least 3000 cps, in other embodiments at least 3200 cps, and in other embodiments at least 3300 cps is achieved (#3 spindle @ 71° F.-73° F.).

### INDUSTRIAL APPLICABILITY

In one or more embodiments, the adhesive composition of the present invention may be employed as a contact adhesive in roofing applications. In particular embodiments, the contact adhesive may be employed to fully secure a membrane panel to a substrate on a roof deck. In particular embodiments, the adhesive may be employed in preparing a fully-adhered roofing membrane system. In other embodiments, the contact adhesive may be used for securing membrane panel or flashing to vertical surfaces within a roofing system.

Practice of the present invention is not necessarily limited by the selection of a particular roofing membrane that is secured to a substrate on a roof surface. As is known in the art, numerous roofing membranes have been proposed in the art and several are used commercially including thermoset and thermoplastic roofing membranes. Commercially available thermoplastic roofing membranes may include polyvinyl chloride, or polyolefin copolymers. For example, thermoplastic olefin (TPO) membranes are available under the trade names UltraPly™, and ReflexEON™ (Firestone Building Products). Commercially available thermoset roofing membranes may include elastomeric copolymers such as ethylene-propylene-diene copolymer (EPDM) rubber and functionalized olefins such as chlorosulfonated polyethylene (CSPE). For example, EPDM membranes are available under the trade name RubberGard™, RubberGard Platinum™, RubberGard EcoWhite™, and RubberGard MAX™ (Firestone Building Products).

In particular embodiments, EPDM membranes are employed. As is known in the art, EPDM membrane panels include vulcanized or cured rubber compositions. These compositions may include, in addition to the rubber that is ultimately vulcanized, fillers, processing oils, and other desired ingredients such as plasticizers, antidegradants, adhesive-enhancing promoters, etc., as well as vulcanizing agents such as sulfur or sulfur-donating compounds.

In one or more embodiments, the EPDM roofing panels have a thickness in accordance with ASTM D-4637-04. In one or more embodiments, the EPDM roofing panels have a thickness of at least 45 mil±10%, in other embodiments at least 60 mil±10%, and in other embodiments at least 90 mil±10%. In these or other embodiments, the EPDM roofing panels may have a thickness of less than 65 mil±10%, in other embodiments less than 80 mil±10%, and in other embodiments less than 110 mil±10%.

In one or more embodiments, the bonding adhesive may be applied to at least a portion of a membrane panel or flashing to form a wet film of the composition on at least a portion of the membrane. In preparing a fully-adhered system, substantially one side of the membrane panel is coated with the composition to form a wet film over a substantial portion of the membrane.

In one or more embodiments, the substrate to which the membrane panel or flashing is ultimately attached is likewise provided with a film of the adhesive compositions. In other words, the adhesive composition is applied to at least a portion of the substrate.

In one or more embodiments, the wet film applied to the membrane and/or the substrate can be at least 7 mils, in other embodiments at least 10 mils, in other embodiments at least 13 mils, and in other embodiments at least 15 mils thick (wet film thickness). In these or other embodiments, the wet film thickness on each of the respective layers may be less than 30 mils, in other embodiments less than 25 mils, in other embodiments less than 18 mils, and in other embodiments less than 15 mils thick (wet film thickness). It has advantageously been discovered that practice of the present invention allows for application of a thinner wet film than has been previously employed using conventional bond adhesives while achieving technologically useful bond adhesion. As a result, during use of the bond adhesive, the application rate can be reduced (i.e., less bond adhesive is needed per square foot, which translates into an increased application rate). For example, in one or more embodiments, technologically useful adhesion can be achieved at application rates of at least 50 square foot per gallon, in other embodiments at least 60 square foot per gallon, in other embodiments at least 70 square foot per gallon, in other embodiments at least 80 square foot per gallon, in other embodiments at least 90 square foot per gallon, and in other embodiments at least 100 square foot per gallon.

In either event, the adhesive composition can be applied by known methods such as manual rollers that require dipping of the roller into the adhesive composition, power rollers, drop spreaders, or spraying such as by conventional spray rigs for applying bond adhesives.

Once a wet film is formed on the membrane and/or substrate, sufficient time is allowed to allow the adhesive film to set up. As is known in the art, the process of setting up the film layer includes the evaporation of at least a portion of the solvent component of the adhesive, which may increase the tackiness and green strength of the adhesive film. In any event, sufficient time is provided to allow enough solvent to evaporate (i.e., allow the film to dry) to an extent that it does not move with finger pressure. While somewhat subjective, those skilled in the art know this standard by the touch-push test.

Once the film has been given sufficient time to set up, the membrane can be mated to the substrate by contacting the two film surfaces together.

### EXAMPLES

### Preparation of Bond Adhesives

Several bond adhesives were prepared. In general, the bond adhesives were prepared in a batch mixer equipped with a disperser blade and a high speed mixer/emulsifier. The mixing took place under atmospheric conditions of temperature and pressure. In general, the solvents were first introduced to the mixer and the solids portion and the water were subsequently added. Mixing took place for about 160 to about 190 minutes. The recipe employed for each of the bond adhesive compositions is set forth in Table I. The amounts shown in Table I are set forth in parts by weight. The rubber component of Sample 1 included about 21.1% by weight low viscosity polychloroprene, about 63.40% by weight high viscosity polychloroprene, and about 15.50% by weight poly-(styrene-co-butadiene). The rubber component of Samples 2-6 included about 21.1% by weight low viscosity polychloroprene, about 63.40% by weight high viscosity polychloroprene, and about 15.50% by weight poly-(styrene-co-butadiene).

TABLE I

| | Sample | Sample | Sample | Sample | Sample | Sample |
|---|---|---|---|---|---|---|
| Chemical | 1 | 2 | 3 | 4 | 5 | 6 |
| Rubber | 100 | 100 | 100 | 100 | 100 | 100 |
| Toluene | 268 | 41.5 | 7.1 | 24.8 | 60.3 | 78.0 |
| tert-butyl | 0.00 | 298 | 332 | 315 | 279 | 261 |
| Acetate | | | | | | |
| Textile Spirits | 193 | 0.00 | 0.00 | 0.00 | 0.00 | 0.00 |
| Acetone | 48.4 | 181 | 181 | 181 | 181 | 181 |
| Xylene | 5.3 | 0.00 | 0.00 | 0.00 | 0.00 | 0.00 |
| Methyl Acetate | 0.00 | 20.1 | 20.1 | 20.1 | 20.1 | 20.1 |
| Water | 1.0 | 1.0 | 1.0 | 1.0 | 1.0 | 1.0 |
| Butyl Phenol | 37.0 | 37.0 | 37.0 | 37.0 | 37.0 | 37.0 |
| Resin | | | | | | |
| MgO | 5.8 | 5.8 | 5.8 | 5.8 | 5.8 | 5.8 |
| Antioxidant | 1.1 | 1.1 | 1.1 | 1.1 | 1.1 | 1.1 |
| ZnO | 2.2 | 2.1 | 2.1 | 2.1 | 2.1 | 2.1 |
| Hydrocarbon | 21.1 | 21.1 | 21.1 | 21.1 | 21.1 | 21.1 |
| Resin | | | | | | |

The butyl phenol resin was obtained under the tradename HRJ-1367 (SI Group); the low viscosity polychloroprene was obtained under the tradename Baypren 213-1 (Bayer Material Science); the high viscosity polychloroprene was obtained under the tradename Baypren 233-1 (Bayer Material Science); the poly(styrene-co-butadiene) was obtained under the tradename Duradene 739 (Firestone Polymers); and the chlorinated polypropylene adhesion promoter was obtained under the tradename Hardlen 13LP (Advanced Polymer, Inc.).

### Peel Adhesion Experiments

The bond adhesive compositions prepared above were tested according to ASTM D903, with the following modifications. The rate of peel was conducted at 2 in/min, and the aluminum samples were 3 in. wide. As shown in the table, the samples were conditioned (i.e., aged) for both 24 hours and 7 days at both room temperature and 158° F. As shown in Table II, each adhesive was tested for peel adhesion to plywood and aluminum. Also, each adhesive was tested twice at each condition and Table II provides an average for each series as well as an overall average.

TABLE II

| Samples | | | | | |
|---|---|---|---|---|---|
| 1 | 2 | 3 | 4 | 5 | 6 |

Peels EPDM to Plywood

| | | | | | | | | | | | | |
|---|---|---|---|---|---|---|---|---|---|---|---|---|
| Comparatives | A | B | A | B | A | B | A | B | A | B | A | B |
| 24 hrs @ RT | 4.35 | 4.66 | 5.45 | 5.59 | 5.42 | 5.19 | 5.08 | 6.47 | 5.99 | 5.42 | 5.76 | 5.36 |
| 24 hrs @ | 2.61 | 2.53 | 2.66 | 2.47 | 2.15 | 2.37 | 2.26 | 2.22 | 3.57 | 3.17 | 2.47 | 2.27 |
| 158 F. | | | | | | | | | | | | |
| 7 days @ RT | 3.18 | 2.41 | 3.91 | 2.75 | 4.02 | 2.95 | 3.63 | 2.56 | 3.73 | 2.35 | 3.26 | 2.31 |
| 7 days @ | 2.63 | 2.14 | 2.80 | 2.02 | 1.75 | 1.69 | 2.40 | 2.41 | 2.30 | 1.63 | 2.12 | 2.00 |
| 158 F. | | | | | | | | | | | | |
| Average - | 3.19 | 2.94 | 3.71 | 3.21 | 3.34 | 3.05 | 3.34 | 3.42 | 3.90 | 3.14 | 3.40 | 2.99 |
| Each | | | | | | | | | | | | |

| | | | | | | |
|---|---|---|---|---|---|---|
| Average - | 3.07 | 3.46 | 3.20 | 3.38 | 3.52 | 3.20 |
| Both | | | | | | |

Peels EPDM to Aluminum

| | | | | | | | | | | | | |
|---|---|---|---|---|---|---|---|---|---|---|---|---|
| Comparatives | A | B | A | B | A | B | A | B | A | B | A | B |
| 24 hrs @ RT | 6.04 | 3.47 | 6.07 | 5.52 | 6.35 | 5.51 | 6.20 | 5.50 | 6.00 | 5.64 | 6.27 | 5.22 |
| 24 hrs @ | 2.93 | 2.40 | 2.32 | 2.05 | 3.14 | 2.06 | 2.64 | 1.88 | 2.93 | 1.93 | 2.50 | 2.11 |
| 158 F. | | | | | | | | | | | | |
| 7 days @ RT | 3.18 | 2.55 | 9.94 | 2.93 | 4.02 | 4.69 | 3.63 | 2.68 | 3.73 | 3.66 | 3.26 | 2.26 |
| 7 days @ | 2.39 | 2.30 | 2.75 | 2.14 | 2.96 | 1.63 | 2.64 | 1.61 | 2.31 | 2.15 | 2.71 | 1.59 |
| 158 F. | | | | | | | | | | | | |
| Average - | 3.64 | 2.68 | 3.76 | 3.16 | 4.12 | 3.47 | 3.78 | 2.92 | 3.74 | 3.36 | 3.69 | 2.80 |
| Each | | | | | | | | | | | | |

| | | | | | | |
|---|---|---|---|---|---|---|
| Average - | 3.16 | 3.46 | 3.80 | 3.35 | 3.54 | 3.25 |
| Both | | | | | | |

Physical Properties

| | | | | | | |
|---|---|---|---|---|---|---|
| Viscosity @ | 3440 | 3360 | 3380 | 3320 | 3370 | 3460 |
| 10 rpm (cps) | | | | | | |
| Solids (%) | 24.40 | 23.70 | 23.70 | 23.50 | 23.50 | 23.70 |
| Weissenberg | 5 | 0 | 4 | 1 | 4 | 4 |
| (mm) | | | | | | |

### Wind Uplift Testing

The adhesive of Samples 1 and 2 were tested according to the Factory Mutual wind uplift rating test (FM 4470). The test sample for Sample 1 was prepared on a 22 gauge steel deck grade E, 1.5 in isocyanurate insulation board (ISO 95+ GL Firestone Building Products) mechanically fastened with fasteners (HD Firestone Building Products) and plates at 18 per 4×8 board, 45 mil standard EPDM fully adhered with Sample 1 bonding adhesive at 82.5 sq. ft. per gallon. The test sample for Sample 2 was prepared on a 22 gauge steel deck grade E, 1.5 in isocyanurate insulation board (ISO 95+ GL Firestone Building Products) mechanically fastened with fasteners (HD Firestone Building Products) and plates at 18 per 4×8 board, 45 mil standard EPDM fully adhered with Sample 2 bonding adhesive at 100.9 sq. ft. per gallon.

The results for Sample 1 included the occurrence of blisters around the parameter at 45 psf. At 60 psf, the blisters continued to propagate but did not cause a drop in pressure. System failure at 42 seconds into 75 psf due to adhesive cohesive failure.

The test results for Sample 2 included the following. The hose off the top of the monometer was disconnected during the initial pressurization which caused Sample 2 to deflect and some blisters to form. The test was stopped and the blisters were isolated with batten. Near the end of 90 psf, numerous blisters the size of baseballs occurred. These blisters propagated during 105 psf; however no loss in pressure occurred. The system failed at 16 seconds into 120 psf due to adhesive cohesive failure and facer delamination.

Various modifications and alterations that do not depart from the scope and spirit of this invention will become apparent to those skilled in the art. This invention is not to be duly limited to the illustrative embodiments set forth herein.

What is claimed is:

1. An adhesive composition comprising:
i. a solids component, said solids component including a rubber component that includes polychloroprene, where the solids component includes at least 20 parts by weight thermosetting resin per 100 parts by weight rubber, and where the rubber component includes at least 70% by weight polychloroprene; and
ii. a solvent component, where the solvent component includes at least 150 parts and less than 500 parts by weight t-butyl acetate, and at least 30 parts and less than 50 parts by weight toluene per 100 parts by weight rubber.

2. The composition of claim 1, where the rubber component further includes poly-(styrene-co-butadiene).

3. The composition of claim 1, where the rubber component is devoid of a complementary rubber, and where the solids component includes an adhesion promoter.

4. An adhesive composition comprising:
i. a solids component, said solids component including a rubber component, a synthetic thermosetting resin, and a hydrocarbon resin, where the rubber component includes at least 70% by weight polychloroprene; and
ii. a solvent component, said solvent component including at least 150 parts and less than 500 parts by weight t-butyl acetate, and at least 30 parts and less than 50 parts by weight toluene per 100 parts by weight rubber.

5. The adhesive composition of claim 4, where the rubber component includes at least 70% by weight polychloroprene.

6. The adhesive composition of claim 1, where the polychloroprene includes a first polychloroprene characterized by a solution viscosity of from 70 to 215 mPa·s and a second polychloroprene characterized by a solution viscosity of from about 700 to about 1,000 MPa·s.

7. The adhesive composition of claim 6, where the solids component includes at least 20 parts by weight thermosetting resin per 100 parts by weight rubber.

8. The adhesive composition of claim 7, where the solids component includes at least 10 parts by weight hydrocarbon resin per 100 parts by weight rubber.

9. The adhesive composition of claim 8, where the solids component further includes at least 1 part by weight magnesium oxide per 100 parts by weight rubber.

10. The adhesive composition of claim 9, where the solids component includes at least 0.5 parts by weight zinc oxide per 100 parts by weight rubber.

11. The adhesive composition of claim 10, where the solids component includes at least 0.1 parts by weight antioxidant per 100 parts by weight rubber.

12. The adhesive composition of claim 11, where the solids component includes at least 0.5 parts by weight adhesion promoter per 100 parts by weight rubber.

13. The adhesive composition of claim 12, where the adhesion promoter is chlorinated polypropylene.

14. A method of contact bonding a roofing membrane to a substrate, the method comprising:
i. applying a contact adhesive composition to a portion of a roofing membrane panel to form a wet film on the membrane panel;
ii. applying a contact adhesive composition to at least a portion of a substrate to form a wet film on the substrate;
iii. allowing the wet film on the membrane and the wet film on the substrate to set up for desirable contact bonding; and
iv. mating the membrane to the substrate, where the adhesive composition includes
a. a solids component, said solids component including a rubber component, a synthetic thermosetting resin, and a hydrocarbon resin, where the rubber component includes polychloroprene; and
b. a solvent component, said solvent component including at least 150 parts and less than 500 parts by weight t-butyl acetate and at least 30 parts and less than 50 parts by weight toluene per 100 parts by weight rubber.

15. The adhesive composition of claim 2, where said solvent component includes at least 250 parts by weight and less than 500 parts by weight t-butyl acetate and at least 33 parts by weight and less than 50 parts by weight toluene per 100 parts by weight rubber.

16. The adhesive composition of claim 15, where said solvent component includes at least 285 parts by weight t-butyl acetate and at least 35 parts by weight toluene per 100 parts by weight rubber.

17. The adhesive composition of claim 16, where said solvent component includes at least 15 parts by weight methyl acetate per 100 parts by weight rubber.

18. The adhesive composition of claim 4, where said solvent component includes at least 250 parts by weight and less than 500 parts by weight t-butyl acetate and at least 33 parts by weight and less than 50 parts by weight toluene per 100 parts by weight rubber.

19. The adhesive composition of claim 18, where said solvent component includes at least 285 parts by weight t-butyl acetate and at least 35 parts by weight toluene per 100 parts by weight rubber.

20. The adhesive composition of claim 19, where said solvent component includes at least 15 parts by weight methyl acetate per 100 parts by weight rubber.

21. The composition of claim 4, where the rubber component further includes poly-(styrene-co-butadiene).

22. The composition of claim 14, where the rubber component further includes poly-(styrene-co-butadiene).

23. The adhesive composition of claim 14, where said solvent component includes at least 250 parts by weight and less than 500 parts by weight t-butyl acetate and at least 33 parts by weight and less than 50 parts by weight toluene per 100 parts by weight rubber.

24. The adhesive composition of claim 23, where said solvent component includes at least 285 parts by weight t-butyl acetate and at least 35 parts by weight toluene per 100 parts by weight rubber.

25. The adhesive composition of claim 24, where said solvent component includes at least 15 parts by weight methyl acetate per 100 parts by weight rubber.
